(19) United States
(12) Patent Application Publication
(10) Pub. No.: US 2024/0073109 A1
(43) Pub. Date: Feb. 29, 2024

(54) NOTIFICATION OF A NEW MANAGEMENT DOMAIN FEATURE

(71) Applicant: Lenovo (Singapore) Pte. Ltd., New Tech Park (SG)

(72) Inventors: Ishan Vaishnavi, München (DE); Emmanouil Pateromichelakis, Viersen (DE)

(21) Appl. No.: 18/261,085

(22) PCT Filed: Jan. 13, 2021
(86) PCT No.: PCT/EP2021/050500

§ 371 Date: Jul. 11, 2023

(51) Int. Cl. H04L 41/50; H04L 41/0686

(52) U.S. Cl. CPC H04L 41/5058; H04L 41/0686

(57) ABSTRACT

Apparatuses, methods, and systems are disclosed for notification of a new management domain feature. One method includes determining that a new management domain feature is available. The method includes determining at least one entity to be notified about the new management domain feature. The method includes determining an advertisement to be sent to the at least one entity to notify the at least one entity about the new management domain feature. The method includes transmitting the advertisement to the at least one entity.

### FIELD

The subject matter disclosed herein relates generally to wireless communications and more particularly relates to notification of a new management domain feature.

### BACKGROUND

The following abbreviations are herewith defined, at least some of which are referred to within the following description: Third Generation Partnership Project (“3GPP”), 5^{th} Generation (“5G”), 5G System (“5GS”), 5G QoS Indicator (“5QI”), Authentication, Authorization, and Accounting (“AAA”), Positive-Acknowledgment (“ACK”), Application Function (“AF”), Automated Guided Vehicles (“AGV”), Artificial Intelligence (“AI”), Authentication and Key Agreement (“AKA”), Aggregation Level (“AL”), Access and Mobility Management Function (“AMF”), Angle of Arrival (“AoA”), Angle of Departure (“AoD”), Access Point (“AP”), Application Programmable Interface (“API”), Augmented Reality (“AR”), Access Stratum (“AS”), Application Service Provider (“ASP”), Autonomous Uplink (“AUL”), Authentication Server Function (“AUSF”), Authentication Token (“AUTN”), Background Data (“BD”), Background Data Transfer (“BDT”), Beam Failure Detection (“BFD”), Beam Failure Recovery (“BFR”), Binary Phase Shift Keying (“BPSK”), Base Station (“BS”), Buffer Status Report (“BSR”), Bandwidth (“BW”), Bandwidth Part (“BWP”), Control to Control (“C2C”), Cell RNTI (“C-RNTI”), Carrier Aggregation (“CA”), Channel Access Priority Class (“CAPC”), Common API Framework (“CAPIF”), Channel Busy Ratio (“CBR”), Contention-Based Random Access (“CBRA”), Clear Channel Assessment (“CCA”), Common Control Channel (“CCCH”), Control Channel Element (“CCE”), Cyclic Delay Diversity (“CDD”), Code Division Multiple Access (“CDMA”), Control Element (“CE”), Contention-Free Random Access (“CFRA”), Configured Grant (“CG”), Closed-Loop (“CL”), Core Network (“CN”), Coordinated Multipoint (“CoMP”), Category of Requirements (“CoR”), Channel Occupancy Time (“COT”), Cyclic Prefix (“CP”), Channel Quality Indicator (“CQI”), Cyclical Redundancy Check (“CRC”), Communication Service (“CS”), Channel State Information (“CSI”), Channel State Information-Reference Signal (“CSI-RS”), Common Search Space (“CSS”), Control Resource Set (“CORESET”), Discrete Fourier Transform Spread (“DFTS”), Dual Connectivity (“DC”), Downlink Control Information (“DCI”), Downlink Feedback Information (“DFI”), Dynamic Grant (“DG”), Downlink (“DL”), Demodulation Reference Signal (“DMRS”), Data Network (“DN”), Data Network Name (“DNN”), Data Radio Bearer (“DRB”), Discontinuous Reception (“DRX”), Dedicated Short-Range Communications (“DSRC”), Downlink Pilot Time Slot (“DwPTS”), Enhanced Clear Channel Assessment (“eCCA”), Enhanced Mobile Broadband (“eMBB”), Evolved Node B (“eNB”), Enhanced V2X (“eV2X”), Extensible Authentication Protocol (“EAP”), Edge Configuration Server (“ECS”), Edge Enabler Client (“EEC”), Edge Enabler Server (“EES”), Enhanced ICIC (“eICIC”), Effective Isotropic Radiated Power (“EIRP”), Evolved Packet System (“EPS”), European Telecommunications Standards Institute (“ETSI”), Feature Advertising Service Producer (“FASP”), Frame Based Equipment (“FBE”), Frequency Division Duplex (“FDD”), Frequency Division Multiplexing (“FDM”), Frequency Division Multiple Access (“FDMA”), Frequency Division Orthogonal Cover Code (“FD-OCC”), Factory of the Future (“FF”), Fully Qualified Domain Name (“FQDN”), Frequency Range 1—sub 6 GHz frequency bands and/or 410 MHz to 7125 MHz (“FR1”), Frequency Range 2—24.25 GHz to 52.6 GHz (“FR2”), Universal Geographical Area Description (“GAD”), Guaranteed Bit Rate (“GBR”), Guaranteed Flow Bit Rate (“GFBR”), Group Leader (“GL”), 5G Node B or Next Generation Node B (“gNB”), Global Navigation Satellite System (“GNSS”), General Packet Radio Services (“GPRS”), Guard Period (“GP”), Global Positioning System (“GPS”), Generic Public Subscription Identifier (“GPSI”), Global System for Mobile Communications (“GSM”), Generic Network Slice Template (“GST”), Globally Unique Temporary UE Identifier (“GUTI”), Home AMF (“hAMF”), Hybrid Automatic Repeat Request (“HARQ”), Home Location Register (“HLR”), Handover (“HO”), Home PLMN (“HPLMN”), Home Subscriber Server (“HSS”), Hash Expected Response (“HXRES”), Inter-cell Interference Coordination (“ICIC”), Identity or Identifier (“ID”), Information Element (“IE”), Industrial Internet of Things (“IIoT”), International Mobile Equipment Identity (“IMEI”), International Mobile Subscriber Identity (“IMSI”), International Mobile Telecommunications (“IMT”), Information Object Class (“IoC”), Internet-of-Things (“IoT”), Internet Protocol (“IP”), Intelligent Transportation Systems (“ITS”), Key Performance Indicator (“KPI”), Layer 1 (“L1”), Layer 2 (“L2”), Layer 3 (“L3”), Licensed Assisted Access (“LAA”), Local Area Data Network (“LADN”), Local Area Network (“LAN”), Load Based Equipment (“LBE”), Listen-Before-Talk (“LBT”), Logical Channel (“LCH”), Logical Channel Group (“LCG”), Logical Channel Prioritization (“LCP”), Log-Likelihood Ratio (“LLR”), Level of Automation (“LoA”), Line of Sight (“LOS”), Long Term Evolution (“LTE”), LTE Vehicle (“LTE-V”), Multiple Access (“MA”), Medium Access Control (“MAC”), Multimedia Broadcast Multicast Services (“MBMS”), Maximum Bit Rate (“MBR”), Minimum Communication Range (“MCR”), Modulation Coding Scheme (“MCS”), Management Domain (“MD”), Multi-service Digital Distribution System Access System (“MDAS”), Managed Entity (“ME”), Mobile Edge Computing (“MEC”), Master Information Block (“MIB”), Massive IoT (“mIoT”), Multiple Input Multiple Output (“MIMO”), Machine Learning (“ML”), Mobility Management (“MM”), Mobility Management Entity (“MME”), Master Node (“MN”), Management Service (“MnS”), Mobile Network Operator (“MNO”), Mobile Originated (“MO”), Managed Object Instance (“MOI”), Mean Opinion Score (“MOS”), massive MTC (“mMTC”), Maximum Power Reduction (“MPR”), Multi-Radio Dual Connectivity (“MR-DC”), Management System (“MS”), Machine Type Communication (“MTC”), Multiple Transmission and Reception Point (“M-TRP”), Multi User Shared Access (“MUSA”), Non Access Stratum (“NAS”), Narrowband (“NB”), Negative-Acknowledgment or Non-Acknowledgment (“NACK”) or (“NAK”), New Data Indicator (“NDI”), Network Entity (“NE”), Network Exposure Function (“NEF”), Network Exposure Function/Service Capability Exposure Function (“NEF/SCEF”), NEtwork Slice Type (“NEST”), Network Function (“NF”), Non-LOS (“NLOS”), Next Generation (“NG”), NG 5G S-TMSI (“NG-5G-S-TMSI”), Neural Networks (“NN”), Non-Orthogonal Multiple Access (“NOMA”), Non Public Network (“NPN”), New Radio (“NR”), NR Unlicensed (“NR-U”), Network Repository Function (“NRF”), Network Slice as a Service (NsaaS), Network Scheduled Mode (“NS Mode”) (e.g., network scheduled mode of V2X communication resource allocation—Mode-1 in NR V2X and Mode-3 in LTE V2X), Network Slice Instance (“NSI”), Network Slice Selection Assistance Information (“NSSAI”), Network Slice Selection Function (“NSSF”), Network Slice Subnet Instance (“NSSI”), Network Slice Selection Policy (“NSSP”), Operation, Administration, and Maintenance System or Operation and Maintenance Center (“OAM”), Original Equipment Manufacturer (“OEM”), Orthogonal Frequency Division Multiplexing (“OFDM”), Orthogonal Frequency Division Multiple Access (“OFDMA”), Open-Loop (“OL”), Operator Defined Open and Intelligent Radio Access Networks (“O-RAN”), Other System Information (“OSI”), Over-the-top (“OTT”), Power Angular Spectrum (“PAS”), Physical Broadcast Channel (“PBCH”), Power Control (“PC”), UE to UE interface (“PC5”), Principal Component Analysis (“PCA”), Policy and Charging Control (“PCC”), Primary Cell (“PCell”), Policy and Charging Rules Function (“PCRF”), Policy Control Function (“PCF”), Physical Cell Identity (“PCI”), Physical Downlink Control Channel (“PDCCH”), Packet Data Convergence Protocol (“PDCP”), Packet Data Network Gateway (“PGW”), Physical Downlink Shared Channel (“PDSCH”), Pattern Division Multiple Access (“PDMA”), Packet Data Unit (“PDU”), Physical Hybrid ARQ Indicator Channel (“PHICH”), Power Headroom (“PH”), Power Headroom Report (“PHR”), Physical Layer (“PHY”), Public Land Mobile Network (“PLMN”), Precoding Matrix Index (“PMI”), Physical Network Function (“PNF”), Prose Per Packet Priority (“PPPP”), Prose Per Packet Reliability (“PPPR”), PC5 5QI (“PQIs”), Predictive QoS (“P-QoS”), Physical Random Access Channel (“PRACH”), Physical Resource Block (“PRB”), Proximity Services (“ProSe”), Positioning Reference Signal (“PRS”), Physical Sidelink Control Channel (“PSCCH”), Primary Secondary Cell (“PSCell”), Physical Sidelink Feedback Control Channel (“PSFCH”), Physical Uplink Control Channel (“PUCCH”), Physical Uplink Shared Channel (“PUSCH”), QoS Class Identifier (“QCI”), Quasi Co-Located (“QCL”), QoS Flow Indicator (“QFI”), Quality of Experience (“QoE”), Quality of Service (“QoS”), Quadrature Phase Shift Keying (“QPSK”), Registration Area (“RA”), RA RNTI (“RA-RNTI”), Radio Access Network (“RAN”), Random (“RAND”), Radio Access Technology (“RAT”), Serving RAT (“RAT-1”) (serving with respect to Uu), Other RAT (“RAT-2”) (non-serving with respect to Uu), Random Access Procedure (“RACH”), Random Access Preamble Identifier (“RAPID”), Random Access Response (“RAR”), Resource Block Assignment (“RBA”), Resource Element Group (“REG”), Representational State Transfer (“REST”), Rank Indicator (“RI”), RAN Intelligent Controller (“RIC”), Radio Link Control (“RLC”), RLC Acknowledged Mode (“RLC-AM”), RLC Unacknowledged Mode/Transparent Mode (“RLC-UM/TM”), Radio Link Failure (“RLF”), Radio Link Monitoring (“RLM”), Radio Network Information (“RNI”), RNI Service (“RNIS”), Radio Network Temporary Identifier (“RNTI”), Reference Signal (“RS”), Recursive Model (“RM”), Remaining Minimum System Information (“RMSI”), Radio Resource Control (“RRC”), Radio Resource Management (“RRM”), Resource Spread Multiple Access (“RSMA”), Reference Signal Received Power (“RSRP”), Received Signal Strength Indicator (“RSSI”), Real Time (“RT”), Round Trip Time (“RTT”), Receive (“RX”), Service Capability Exposure Function (“SCEF”), Sparse Code Multiple Access (“SCMA”), Service Provider (“SP”), Scheduling Request (“SR”), Sounding Reference Signal (“SRS”), Single Carrier Frequency Division Multiple Access (“SC-FDMA”), Secondary Cell (“SCell”), Secondary Cell Group (“SCG”), Shared Channel (“SCH”), Sidelink Control Information (“SCI”), Sub-carrier Spacing (“SCS”), Space Division Multiplexing (“SDM”), Service Data Unit (“SDU”), Security Anchor Function (“SEAF”), Service Enabler Architecture Layer (“SEAL”), Sidelink Feedback Content Information (“SFCI”), Serving Gateway (“SGW”), System Information Block (“SIB”), SystemInformationBlockType1 (“SIB1”), SystemInformationBlockType2 (“SIB2”), Subscriber Identity/Identification Module (“SIM”), Signal-to-Interference-Plus-Noise Ratio (“SINR”), Sidelink (“SL”), Service Level Agreement (“SLA”), Sidelink Synchronization Signals (“SLSS”), Session Management (“SM”), Session Management Function (“SMF”), Service Management and Orchestration (“SMO”), Secondary Node (“SN”), Special Cell (“SpCell”), Single Network Slice Selection Assistance Information (“S-NSSAI”), Semi-Persistent Scheduling (“SPS”), Scheduling Request (“SR”), Signaling Radio Bearer (“SRB”), Shortened TMSI (“S-TMSI”), Shortened TTI (“sTTI”), Synchronization Signal (“SS”), Survival Time (“ST”), Sidelink CSI RS (“S-CSI RS”), Sidelink PRS (“S-PRS”), Sidelink SSB (“S-SSB”), Synchronization Signal Block (“SSB”), Subscription Concealed Identifier (“SUCI”), Scheduling User Equipment (“SUE”), Supplementary Uplink (“SUL”), Subscriber Permanent Identifier (“SUPI”), Support Vector Machine (“SVM”), Tracking Area (“TA”), TA Identifier (“TAI”), TA Update (“TAU”), Timing Alignment Timer (“TAT”), Transport Block (“TB”), Transport Block Size (“TBS”), Transmission Configuration Indicator (“TCI”), Time-Division Duplex (“TDD”), Time Division Multiplexing (“TDM”), Time Division Orthogonal Cover Code (“TD-OCC”), Time Domain Resource Allocation (“TDRA”), Temporary Mobile Subscriber Identity (“TMSI”), Time of Flight (“ToF”), Transmission Power Control (“TPC”), Transmission and Reception Point (“TRP”), Time Sensitive Communication (“TSC”), Time Sensitive Assistance Information (“TSCAI”), Time Sensitive Networking (“TSN”), Transmission Time Interval (“TTI”), Transmit (“TX”), Unmanned Aircraft System (“UAS”), Uplink Control Information (“UCI”), Unified Data Management Function (“UDM”), Unified Data Repository (“UDR”), User Entity/Equipment (Mobile Terminal) (“UE”) (e.g., a V2X UE), UE Autonomous Mode (UE autonomous selection of V2X communication resource—e.g., Mode-2 in NR V2X and Mode-4 in LTE V2X. UE autonomous selection may or may not be based on a resource sensing operation), Uplink (“UL”), UL SCH (“UL-SCH”), Universal Mobile Telecommunications System (“UMTS”), User Plane (“UP”), UP Function (“UPF”), Uplink Pilot Time Slot (“UpPTS”), Uniform Resource Identifier (“URI”), Uniform Resource Locator (“URL”), Ultra-reliability and Low-latency Communications (“URLLC”), UE Route Selection Policy (“URSP”), Vehicle-to-Vehicle (“V2V”), Vehicle-to-Everything (“V2X”), V2X Control Function (“V2XCF”), V2X UE (e.g., a UE capable of vehicular communication using 3GPP protocols), V2X Application Enabler (“VAE”), Visiting AMF (“vAMF”), Virtual Network Function (“VNF”), Visiting NSSF (“vNSSF”), Visiting PLMN (“VPLMN”), Virtual Reality (“VR”), Wide Area Network (“WAN”), and Worldwide Interoperability for Microwave Access (“WiMAX”).

In certain wireless communications networks, management entities or managed entities may be used.

### BRIEF SUMMARY

Methods for notification of a new management domain feature are disclosed. Apparatuses and systems also perform the functions of the methods. One embodiment of a method includes determining that a new management domain feature is available. In some embodiments, the method includes determining at least one entity to be notified about the new management domain feature. In various embodiments, the method includes determining an advertisement to be sent to the at least one entity to notify the at least one entity about the new management domain feature. In certain embodiments, the method includes transmitting the advertisement to the at least one entity.

One apparatus for notification of a new management domain feature includes a processor that: determines that a new management domain feature is available; determines at least one entity to be notified about the new management domain feature; and determines an advertisement to be sent to the at least one entity to notify the at least one entity about the new management domain feature. In various embodiments, the apparatus includes a transmitter that transmits the advertisement to the at least one entity.

### BRIEF DESCRIPTION OF THE DRAWINGS

A more particular description of the embodiments briefly described above will be rendered by reference to specific embodiments that are illustrated in the appended drawings. Understanding that these drawings depict only some embodiments and are not therefore to be considered to be limiting of scope, the embodiments will be described and explained with additional specificity and detail through the use of the accompanying drawings, in which:

FIG. 1 is a schematic block diagram illustrating one embodiment of a wireless communication system for notification of a new management domain feature;

FIG. 2 is a schematic block diagram illustrating one embodiment of an apparatus that may be used for notification of a new management domain feature;

FIG. 3 is a schematic block diagram illustrating another embodiment of an apparatus that may be used for notification of a new management domain feature;

FIG. 4 is a communications diagram illustrating one embodiment of communications for notification of a new management domain feature;

FIG. 5 is a communications diagram illustrating another embodiment of communications for notification of a new management domain feature;

FIG. 6 is a communications diagram illustrating a further embodiment of communications for notification of a new management domain feature; and

FIG. 7 is a flow chart diagram illustrating one embodiment of a method for notification of a new management domain feature.

### DETAILED DESCRIPTION

As will be appreciated by one skilled in the art, aspects of the embodiments may be embodied as a system, apparatus, method, or program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a program product embodied in one or more computer readable storage devices storing machine readable code, computer readable code, and/or program code, referred hereafter as code. The storage devices may be tangible, non-transitory, and/or non-transmission. The storage devices may not embody signals. In a certain embodiment, the storage devices only employ signals for accessing code.

Certain of the functional units described in this specification may be labeled as modules, in order to more particularly emphasize their implementation independence. For example, a module may be implemented as a hardware circuit comprising custom very-large-scale integration (“VLSI”) circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in code and/or software for execution by various types of processors. An identified module of code may, for instance, include one or more physical or logical blocks of executable code which may, for instance, be organized as an object, procedure, or function. Nevertheless, the executables of an identified module need not be physically located together, but may include disparate instructions stored in different locations which, when joined logically together, include the module and achieve the stated purpose for the module.

Indeed, a module of code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different computer readable storage devices. Where a module or portions of a module are implemented in software, the software portions are stored on one or more computer readable storage devices.

Any combination of one or more computer readable medium may be utilized. The computer readable medium may be a computer readable storage medium. The computer readable storage medium may be a storage device storing the code. The storage device may be, for example, but not limited to, an electronic, magnetic, optical, electromagnetic, infrared, holographic, micromechanical, or semiconductor system, apparatus, or device, or any suitable combination of the foregoing.

More specific examples (a non-exhaustive list) of the storage device would include the following: an electrical connection having one or more wires, a portable computer diskette, a hard disk, a random access memory (“RAM”), a read-only memory (“ROM”), an erasable programmable read-only memory (“EPROM” or Flash memory), a portable compact disc read-only memory (“CD-ROM”), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Code for carrying out operations for embodiments may be any number of lines and may be written in any combination of one or more programming languages including an object oriented programming language such as Python, Ruby, Java, Smalltalk, C++, or the like, and conventional procedural programming languages, such as the “C” programming language, or the like, and/or machine languages such as assembly languages. The code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (“LAN”) or a wide area network (“WAN”), or the connection may be made to an external computer (for example, through the Internet using an Internet Service Provider).

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to,” unless expressly specified otherwise. An enumerated listing of items does not imply that any or all of the items are mutually exclusive, unless expressly specified otherwise. The terms “a,” “an,” and “the” also refer to “one or more” unless expressly specified otherwise.

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Aspects of the embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code. The code may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams block or blocks.

The code may also be stored in a storage device that can direct a computer, other programmable data processing apparatus, or other devices to function in a particular manner, such that the instructions stored in the storage device produce an article of manufacture including instructions which implement the function/act specified in the schematic flowchart diagrams and/or schematic block diagrams block or blocks.

The code may also be loaded onto a computer, other programmable data processing apparatus, or other devices to cause a series of operational steps to be performed on the computer, other programmable apparatus or other devices to produce a computer implemented process such that the code which execute on the computer or other programmable apparatus provide processes for implementing the functions/acts specified in the flowchart and/or block diagram block or blocks.

The schematic flowchart diagrams and/or schematic block diagrams in the Figures illustrate the architecture, functionality, and operation of possible implementations of apparatuses, systems, methods and program products according to various embodiments. In this regard, each block in the schematic flowchart diagrams and/or schematic block diagrams may represent a module, segment, or portion of code, which includes one or more executable instructions of the code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each figure may refer to elements of proceeding figures. Like numbers refer to like elements in all figures, including alternate embodiments of like elements.

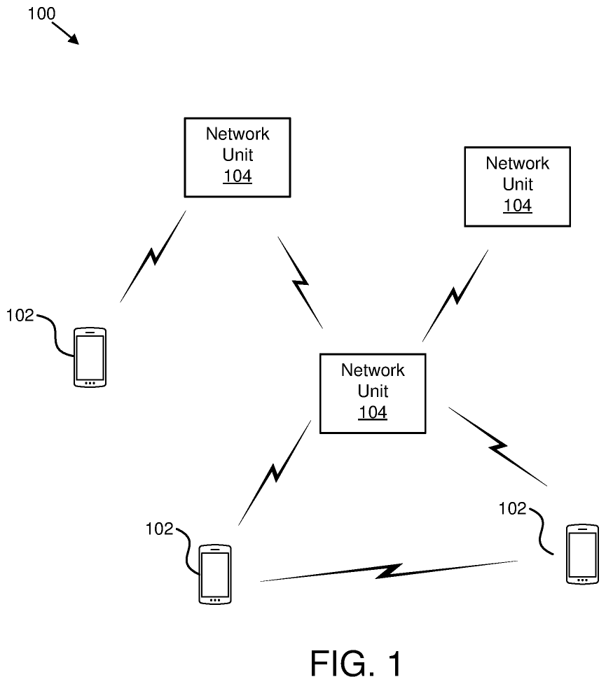

FIG. 1 depicts an embodiment of a wireless communication system 100 for notification of a new management domain feature. In one embodiment, the wireless communication system 100 includes remote units 102, and network units 104. Even though a specific number of remote units 102, and network units 104 are depicted in FIG. 1, one of skill in the art will recognize that any number of remote units 102, and network units 104 may be included in the wireless communication system 100.

In one embodiment, the remote units 102 may include computing devices, such as desktop computers, laptop computers, personal digital assistants (“PDAs”), tablet computers, smart phones, smart televisions (e.g., televisions connected to the Internet), set-top boxes, game consoles, security systems (including security cameras), vehicle on-board computers, network devices (e.g., routers, switches, modems), aerial vehicles, drones, or the like. In some embodiments, the remote units 102 include wearable devices, such as smart watches, fitness bands, optical head-mounted displays, or the like. Moreover, the remote units 102 may be referred to as subscriber units, mobiles, mobile stations, users, terminals, mobile terminals, fixed terminals, subscriber stations, UE, user terminals, a device, or by other terminology used in the art. The remote units 102 may communicate directly with one or more of the network units 104 via UL communication signals. In certain embodiments, the remote units 102 may communicate directly with other remote units 102 via sidelink communication.

The network units 104 may be distributed over a geographic region. In certain embodiments, a network unit 104 may also be referred to and/or may include one or more of an access point, an access terminal, a base, a base station, a Node-B, an eNB, a gNB, a Home Node-B, a relay node, a device, a core network, an aerial server, a radio access node, an AP, NR, a network entity, an AMF, a UDM, a UDR, a UDM/UDR, a PCF, a RAN, an NSSF, an OAM, an SMF, a UPF, an application function, or by any other terminology used in the art. The network units 104 are generally part of a radio access network that includes one or more controllers communicably coupled to one or more corresponding network units 104. The radio access network is generally communicably coupled to one or more core networks, which may be coupled to other networks, like the Internet and public switched telephone networks, among other networks. These and other elements of radio access and core networks are not illustrated but are well known generally by those having ordinary skill in the art.

In one implementation, the wireless communication system 100 is compliant with NR protocols standardized in 3GPP, wherein the network unit 104 transmits using an OFDM modulation scheme on the DL and the remote units 102 transmit on the UL using a SC-FDMA scheme or an OFDM scheme. More generally, however, the wireless communication system 100 may implement some other open or proprietary communication protocol, for example, WiMAX, IEEE 802.11 variants, GSM, GPRS, UMTS, LTE variants, CDMA2000, Bluetooth®, ZigBee, Sigfoxx, among other protocols. The present disclosure is not intended to be limited to the implementation of any particular wireless communication system architecture or protocol.

The network units 104 may serve a number of remote units 102 within a serving area, for example, a cell or a cell sector via a wireless communication link. The network units 104 transmit DL communication signals to serve the remote units 102 in the time, frequency, and/or spatial domain.

In various embodiments, a network unit 104 may determine that a new management domain feature is available. In some embodiments, the network unit 104 may determine at least one entity to be notified about the new management domain feature. In various embodiments, the network unit 104 may determine an advertisement to be sent to the at least one entity to notify the at least one entity about the new management domain feature. In certain embodiments, the network unit 104 may transmit the advertisement to the at least one entity. Accordingly, the network unit 104 may be used for notification of a new management domain feature. As used herein, a management entity may refer to any entity that manages another entity or device (e.g., a management entity may be a management domain, vendor device, vendor solution 5GS operator domain, 3GPP core, 3GPP RAN, cloud domain, datacenter, transport network, operator administrative domain, country domain, LCM, FCAPS management, API management, and so forth). Moreover, as used herein a managed entity may refer to any entity that is managed by another entity or device (e.g., a managed entity may be: API, CS, NSI, NSSI, network functions or other resources in telecom networks such as virtualized network function and/or physical entities such as PNFs).

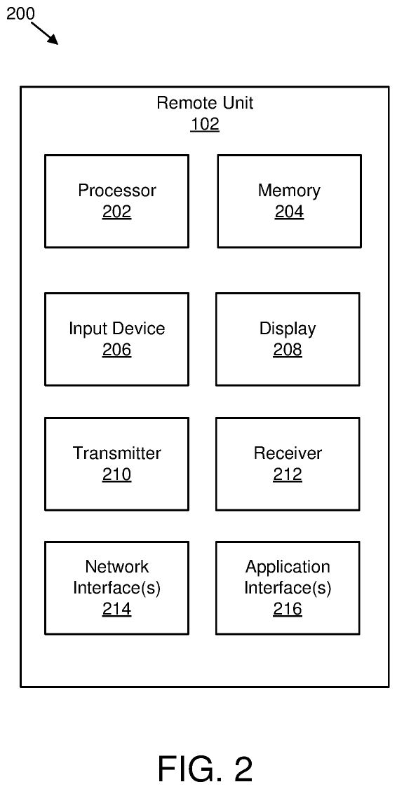

FIG. 2 depicts one embodiment of an apparatus 200 that may be used for notification of a new management domain feature. The apparatus 200 includes one embodiment of the remote unit 102. Furthermore, the remote unit 102 may include a processor 202, a memory 204, an input device 206, a display 208, a transmitter 210, a receiver 212, one or more network interfaces 214, and one or more application interfaces 216. In some embodiments, the input device 206 and the display 208 are combined into a single device, such as a touchscreen. In certain embodiments, the remote unit 102 may not include any input device 206 and/or display 208. In various embodiments, the remote unit 102 may include one or more of the processor 202, the memory 204, the transmitter 210, and the receiver 212, and may not include the input device 206 and/or the display 208.

The processor 202, in one embodiment, may include any known controller capable of executing computer-readable instructions and/or capable of performing logical operations. For example, the processor 202 may be a microcontroller, a microprocessor, a central processing unit (“CPU”), a graphics processing unit (“GPU”), an auxiliary processing unit, a field programmable gate array (“FPGA”), or similar programmable controller. In some embodiments, the processor 202 executes instructions stored in the memory 204 to perform the methods and routines described herein. The processor 202 is communicatively coupled to the memory 204, the input device 206, the display 208, the transmitter 210, and the receiver 212.

The memory 204, in one embodiment, is a computer readable storage medium. In some embodiments, the memory 204 includes volatile computer storage media. For example, the memory 204 may include a RAM, including dynamic RAM (“DRAM”), synchronous dynamic RAM (“SDRAM”), and/or static RAM (“SRAM”). In some embodiments, the memory 204 includes non-volatile computer storage media. For example, the memory 204 may include a hard disk drive, a flash memory, or any other suitable non-volatile computer storage device. In some embodiments, the memory 204 includes both volatile and non-volatile computer storage media. In some embodiments, the memory 204 also stores program code and related data, such as an operating system or other controller algorithms operating on the remote unit 102.

The input device 206, in one embodiment, may include any known computer input device including a touch panel, a button, a keyboard, a stylus, a microphone, or the like. In some embodiments, the input device 206 may be integrated with the display 208, for example, as a touchscreen or similar touch-sensitive display. In some embodiments, the input device 206 includes a touchscreen such that text may be input using a virtual keyboard displayed on the touchscreen and/or by handwriting on the touchscreen. In some embodiments, the input device 206 includes two or more different devices, such as a keyboard and a touch panel.

The display 208, in one embodiment, may include any known electronically controllable display or display device. The display 208 may be designed to output visual, audible, and/or haptic signals. In some embodiments, the display 208 includes an electronic display capable of outputting visual data to a user. For example, the display 208 may include, but is not limited to, an LCD display, an LED display, an OLED display, a projector, or similar display device capable of outputting images, text, or the like to a user. As another, non-limiting, example, the display 208 may include a wearable display such as a smart watch, smart glasses, a heads-up display, or the like. Further, the display 208 may be a component of a smart phone, a personal digital assistant, a television, a table computer, a notebook (laptop) computer, a personal computer, a vehicle dashboard, or the like.

In certain embodiments, the display 208 includes one or more speakers for producing sound. For example, the display 208 may produce an audible alert or notification (e.g., a beep or chime). In some embodiments, the display 208 includes one or more haptic devices for producing vibrations, motion, or other haptic feedback. In some embodiments, all or portions of the display 208 may be integrated with the input device 206. For example, the input device 206 and display 208 may form a touchscreen or similar touch-sensitive display. In other embodiments, the display 208 may be located near the input device 206.

Although only one transmitter 210 and one receiver 212 are illustrated, the remote unit 102 may have any suitable number of transmitters 210 and receivers 212. The transmitter 210 and the receiver 212 may be any suitable type of transmitters and receivers. In one embodiment, the transmitter 210 and the receiver 212 may be part of a transceiver.

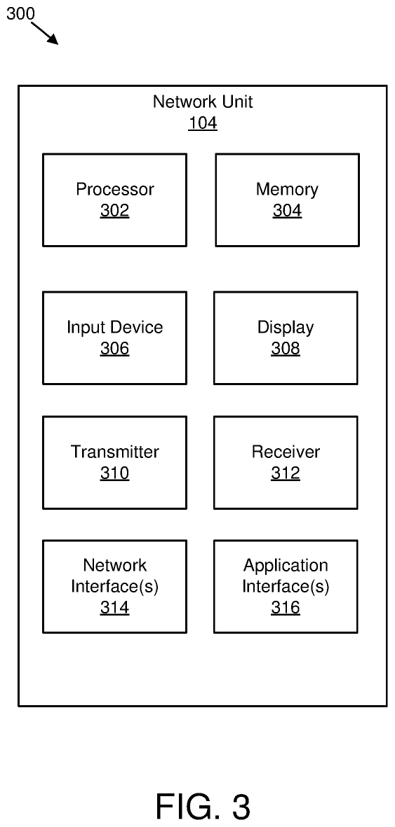

FIG. 3 depicts another embodiment of an apparatus 300 that may be used for notification of a new management domain feature. The apparatus 300 includes one embodiment of the network unit 104. Furthermore, the network unit 104 may include a processor 302, a memory 304, an input device 306, a display 308, a transmitter 310, a receiver 312, one or more network interfaces 314, and one or more application interfaces 316. As may be appreciated, the processor 302, the memory 304, the input device 306, the display 308, the transmitter 310, and the receiver 312 may be substantially similar to the processor 202, the memory 204, the input device 206, the display 208, the transmitter 210, and the receiver 212 of the remote unit 102, respectively.

In certain embodiments, the processor 302 may: determine that a new management domain feature is available; determine at least one entity to be notified about the new management domain feature; and determine an advertisement to be sent to the at least one entity to notify the at least one entity about the new management domain feature. In various embodiments, the transmitter 310 may transmit the advertisement to the at least one entity.

In some embodiments, a third party application, such as a V2X application, may use telecom management system services to manage telecom networks that the third party application may use. In such embodiments, the telecom management system may need to be made aware of these applications. Further, in such embodiments, the telecom management system may need to advertise its capabilities to one or more third party applications. Moreover, in such embodiments, a telecommunication management system may refer to management systems according to a specification of telecom standard bodies such as 3GPP or ETSI.

In certain embodiments, network slicing is a key feature (e.g., 5G). In such embodiments, network slicing may introduce logical end-to-end sub-networks corresponding to different verticals. In some embodiments, network slicing may enable the deployment of multiple logical networks known as network slice instances offering 3rd parties and verticals customized communication services on the top of a shared infrastructure. In various embodiments, based on a physical network that might be operated by a public operator or an enterprise, 5G may provide the means to run multiple slices for different communication purposes. In certain embodiments, 5G may enable slices to be independently run and/or isolated from one another.

In some embodiments, a network slice instance (e.g., private or public slice) may include a RAN part and/or a CN part. In various embodiments, a sub-part of a network slice instance may be called a network slice subnet instance (NSSI) which may contain further NSSI.

In certain embodiments, there may be application support for slices, such as in 3GPP 5GS. An application, as used herein, refers to an application server, an application client, an application enabler server, an application enabler client, and/or an API invoker. Such terms may be understood in 3GPP and/or may be defined in TS23.434, TS 23.222, TS 23.558, TS 23.286, and/or TS 23.501. In various embodiments, if there are changes in a management system or capabilities (e.g., upgrades, new coverage area, newer features, etc.) there may be a way for the management system to advertise these to applications (e.g., that are already using the management service or to other applications that haven't yet used the management system). In some embodiments, an application may use any one of the following managed entities: CS, NSI, NSSI, network functions or other resources in telecom networks such as virtualized network function and/or physical entities such as PNFs and may be interest in receiving capability notifications when capabilities of a management system change. In some embodiments, an application may provide network related optimizations using analytic (e.g., such as from an RIC platform).

In one example, an operator may install newer capabilities (e.g., support for a new coverage area or new types of slices such as for gaming or online video applications). In this example, there may be application programmers or existing applications that may be interested in extending their user base to a new coverage area. The management system may have this information based on previous requests from such applications. In such an example, an operator may automatically want to advertise the availability of these new capabilities to application programmers, application administrators, or to the application.

In such an example, the management system of a 5GS operator (e.g., a management domain) may advertise to ASP applications new capabilities that the management system has acquired. For example, the management system may: 1) receive interest from applications, their programmers, or their administrators on the capabilities that applications would like to have; and/or 2) together with the new capabilities, advertise management services available to manage such capabilities (e.g., including management data).

As used herein, non-RT RIC may mean: a logical function that enables non-real-time control and optimization of RAN elements and resources, AI/ML workflow including model training and updates, and policy-based guidance of applications and/or features in Near-RT RIC.

Moreover, as used herein, near-RT RIC and framework functions may mean: a logical function that enables near-real-time control and optimization of RAN elements and resources via fine-grained (e.g., UE basis, cell basis) data collection and actions over an E2 interface. Near-RT RIC may include near-RT RIC basic and/or framework functions which may include subscription management, conflict mitigation, E2 termination (“E2T”), and/or management services.

Furthermore, as used herein, management Services of an RIC platform may include Life-Cycle Management (“LCM”) of an xApp and/or fault, configuration, accounting, performance, security (“FCAPS”) management of Near-RT RIC. These services may be provided by a near-RT RIC to an xApp (e.g., via Open API) or from an SMO (Non-RT RIC) to xApps (via O1).

An xApp as used herein may mean: an application designed to run on a Near-RT RIC. Such an application may be likely to include one or more microservices and at a point of on-boarding may identify which data it consumes and which data it provides. The xApp application is independent of a Near-RT RIC and may be provided by any third party. E2 may enable a direct association between the xApp and RAN functionality.

Moreover, as used herein rApp may mean: an application similar to xApp which is designed to run on a Non-RT RIC. Furthermore, A1 may be an interface between non-RT RIC and Near-RT RIC to enable policy-driven guidance of Near-RT RIC applications and/or functions, and may support AI and/or ML workflow. E2 may refer to an interface connecting a Near-RT RIC and a NR system. Moreover, O1 may refer to an interface between orchestration & management entities and O-RAN managed elements.

In various embodiments, an E2 Node may be a logical node terminating an E2 interface. Moreover, in some embodiments, open API may be an interface between framework functions and xAPPs.

In some embodiments, open API and/or O-RAN API may refer to an interface between framework functions and xAPPs.

In certain embodiments, API management services may enable a RIC platform to provide support for O-RAN APIs (e.g., O-RAN APIs may be defined as open APIs within an O-RAN scope) which may be provided by either a RIC framework or xApps in a service-based manner. In particular, API management services may include: repository and/or registry services for the O-RAN APIs, services that enable discovery of registered O-RAN APIs, services to authenticate xApps for use of O-RAN APIs, and/or services that enable generic subscription and event notification.

In various embodiments, API management services may be accessed via an xApp enablement API by xApps for supporting API discovery, providing authentication, and generic subscription and event notification.

In some embodiments, an application support layer may be used for vertical applications (e.g., known as vertical application enabler layer) which may act as a middleware for exposing northbound APIs to verticals as well as to provide some server-client support functionalities for the connected devices.

In certain embodiments, to be able to use management services and data, a management exposure for applications needs to be configured in a management system. This may require that the management system is aware of these applications. Moreover, a management system may advertise its capabilities externally.

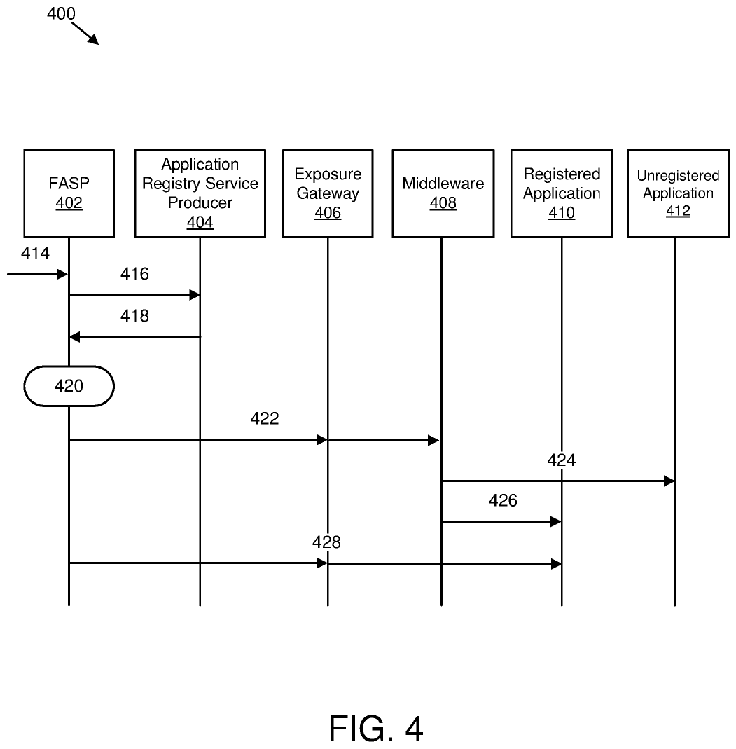

FIG. 4 is a communications diagram illustrating one embodiment of communications 400 for notification of a new management domain feature. The communications 400 include messages transmitted between a FASP 402, an application registry service producer 404 (e.g., in an MD), an exposure gateway 406 (e.g., from MD, including exposure governance interface), a middleware 408 (e.g., or trusted application, preauthorized to use the application registry service producer 404), a registered application 410 (e.g., or registered applications), and an unregistered application 412 (e.g., or unregistered applications). As may be appreciated, each communication of the communications 400 may include one or more messages. As used herein, a FASP may be any entity or collection of entities that supports functionalities performed by the FASP 402 described herein.

To use new or modified capabilities and/or features of a management system, applications need to be made aware of the existence of such capabilities and/or features. One embodiment for a management system making applications aware of the existence of new or modified capabilities and/or features is illustrated in FIG. 4.

In the embodiment illustrated in FIG. 4: 1) registered and/or unregistered applications exist—the management domain and/or management system may be aware of registered applications but may be unaware of unregistered applications; 2) there may be an entity trusted by the management domain which is used by 3^{rd} party unregistered and/or registered application to receive capability advertisements; 3) all new features and/or capabilities may come with a pre-configured exposure (e.g., configurable by an operator)—the exposure may be used to decide which application can see which information regarding a capability and/or feature, some default public information may be provided—it should be noted that exposure may refer to permissions that a 3^{rd} party entity has gained over its use of a management service—for example, the ability to read, execute, modify, and/or delete may be considered examples of exposure; 4) a feature may refer to anything of use offered by a management system to a 3^{rd} party application—for example, a new feature may be (but is not limited to): a) a new or modified managed entity—such as a new network function; b) any new software, hardware, or other functionality—for example, new technology support, new coverage area, new network slice type or instance, new NFs, and/or new network slice subnet type or instance; c) a new management service and/or function or management API; d) support of a new 3GPP releases or other standard specification releases—for example, R16 or R17; and/or e) new types or modified types of management data.

In a first communication 414 transmitted to, determined by, and/or discovered by the FASP 402, a new or modified feature and/or capability may be discovered or registered with the FASP 402 by an operator, using an inventory management service, and/or using other discovery services. Default exposure details for the feature and/or capability may be configured in information transmitted to, determined by, and/or discovered by the FASP 402. As may be appreciated, modified features may include deleted or discontinued features.

In a second (optional) communication 416 transmitted from the FASP 402 to the application registry service producer 404, the FASP 402 may get an address list of registered applications and/or trusted applications from the application registry service producer 404 along with their exposure level information. The registered applications and/or trusted applications may voluntarily subscribe to updates or have the ability to switch receiving any updates. The exposure level information may include: 1) which information, data, MoI, IoC, and/or management and managed entities an application may read, use, modify, create, delete, and/or so forth—life cycle management operations of an entity; and/or 2) for trusted entities and/or trusted application, the information that may be publicly forwarded to applications (or application developers) that may be interested in viewing that information.

In a third (optional) communication 418 transmitted from the application registry service producer 404 to the FASP 402, the application registry service producer 404 provides the requested information to the FASP 402. As may be appreciated, the application registry service producer 404 may be collocated with any other entity including the exposure gateway 406.

The FASP matches 420 parts of the new or modified features with regards to the exposure permitted with the exposure allowance of each entity whose address is received in step 418. For example, unregistered applications may only be allowed to see public information (e.g., description) of a new or modified feature, and registered applications may have access to use the new or modified feature. In certain embodiments, if registered and/or trusted entities and/or applications have actively subscribed to receive updates—this information is taken into consideration. For example, trusted applications may only subscribe to changes in a particular service area.

In a fourth communication 422 transmitted from the FASP 402 to the exposure gateway 406 and/or the middleware 408, the FASP 402 sends an advertisement determined in step 420 to an address of the middleware 408. This advertisement may be sent via the exposure gateway 406, in certain embodiments.

In a fifth communication 424 transmitted from the middleware 408 to the unregistered application 412, the middleware 408 may forward an advertisement for the unregistered application 412 to the unregistered application 412 (e.g., to an address of the unregistered application 412) having the correct exposure level. Thus, the unregistered application 412 may be made aware of the new and/or modified feature of step 414.

In a sixth communication 426 transmitted from the middleware 408 to the registered application 410, the middleware 408 entity may forward an advertisement for the registered application 410 to the registered application 410 (e.g., to an address of the registered application 410) having the correct exposure level (e.g., applications registered with an advertising management system).

In a seventh (optional) communication 428 transmitted from the FASP 402 to the registered application 410 (e.g., optionally via the exposure gateway 406), the FASP 402 sends an advertisement to the registered application 410 (e.g., to an address of the registered application 410).

As may be appreciated, the order of steps 414 through 428 may be changed. Moreover, the FASP 402, the application registry service producer 404, and/or the exposure gateway 406 may be part of the same entity or may be separate entities.

In some embodiments, any entity may receive an advertisement from the FASP 402. Such an entity may be any entity external to the management domain—for example, a webserver (e.g., the entity doesn't have to be the middleware 408 and/or an application).

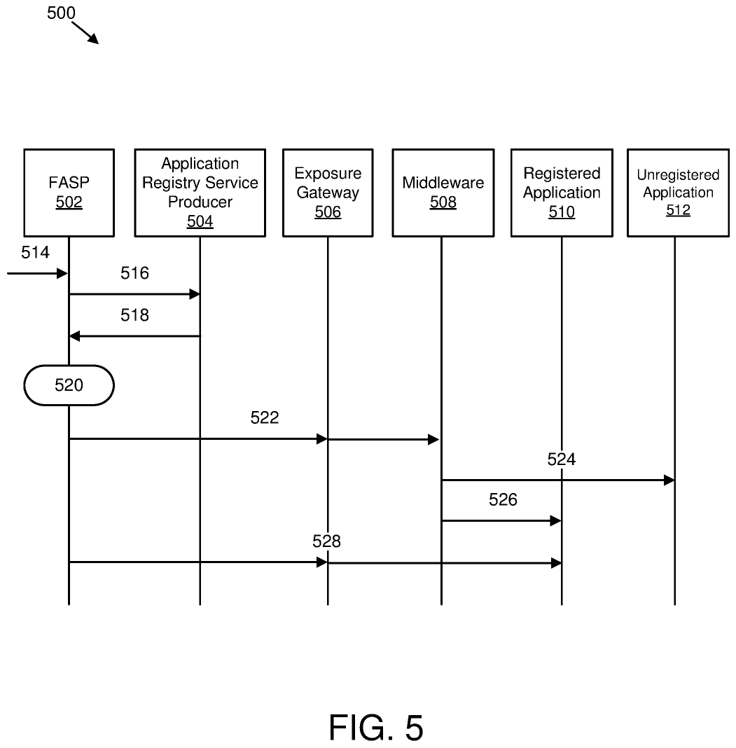

In one embodiment, the communications 400 of FIG. 4 may be implemented in a 3GPP system. FIG. 5 is a communications diagram illustrating one embodiment of communications 500 for notification of a new management domain feature (e.g., 3GPP based). The communications 500 include messages transmitted between a FASP 502 (e.g., in a 3GPP domain), an application registry service producer 504 (e.g., in a 3GPP domain), an exposure gateway 306 (e.g., to the 3GPP domain), a middleware 508, a registered application 510 (e.g., or registered applications), and an unregistered application 512 (e.g., or unregistered applications). As may be appreciated, each communication of the communications 500 may include one or more messages.

FIG. 5 illustrates a 3GPP specific embodiment in which a management domain or a management system may advertise new, modified, and/or deleted features to 3^{rd} party applications (e.g., vertical applications). Applications may be classified as application already registered with a 3GPP management domain of an operator or unregistered applications that are known to a trusted middleware (e.g., a SEAL server, any other vertical enabler server, a CAPIF entity, or an edge enabler and/or configuration server). In the embodiment illustrated in FIG. 5: 1) there may be a set of middleware instances trusted by a 3GPP management domain that acts on behalf of the 3GPP management domain to advertise new capabilities to unregistered or registered applications to provide new capabilities; 2) a list of registered applications is available from a management service provider (e.g., from the application registry service producer 504); 3) the 3GPP management domain or management system is aware of the list of registered applications and allowed exposure levels for those applications; 4) known middleware instances may be aware of applications not registered with the 3GPP MS or MS; and/or 5) registered applications may subscribe to certain limited types of changes (e.g., new or modified) features.

In a first communication 514 transmitted to, determined by, and/or discovered by the FASP 402, the FASP 402 is configured with or discovers new or modified features in a 3GPP MD or MS. The features may include (but are not limited to): changes and/or updates in 3GPP release support; new management service producers; new managed entities—such as new radio, new technology, and/or new NFs; new technical support—such as support in a new geography and/or coverage area; changes in MoIs; and/or availability of new management data—such as data related to energy usage, sessions, and/or slice performance.

In a second communication 516 transmitted from the FASP 502 to the application registry service producer 504, the FASP 502 may get a list of trusted middleware and/or registered applications from the application registry service producer 504 or any other NF in the management system that has this information. The information may include any combination of the following: 1) addresses one or more registered applications; 2) addresses of one or more trusted middleware; 3) information relating to allowed exposure to the one or more registered applications and/or the one or more trusted middleware; and/or 4) any relevant contextual information.

In a third communication 518 transmitted from the application registry service producer 504 to the FASP 502, the application registry service producer 504 provides the requested information to the FASP 502.

The FASP 502, based on an exposure level configured by the new and/or modified features and exposure levels of registered applications and trusted middleware, determines the right “advertisement” of the new and/or modified feature to be sent. For example, if a new feature is a new MnS and a registered application does not have enough exposure to see this new MnS, then no advertisement may be sent to the registered application 510. In some embodiments, an amount of information that the middleware 508 may forward to unregistered and/or registered applications may be derived—this information may be sent to the middleware 508. In certain embodiments, there may be registered applications that are hidden behind the middleware 508 and may not be directly addressable by the management domain.

In a fourth communication 522 transmitted from the FASP 502 to the exposure gateway 506 and/or the middleware 508, the FASP 502 sends an advertisement determined in step 520 to an address of the middleware 508. This advertisement may be sent via the exposure gateway 506, in certain embodiments.

In a fifth communication 524 transmitted from the middleware 508 to the unregistered application 512, the middleware 508 may forward an advertisement for the unregistered application 512 to the unregistered application 512 (e.g., to an address of the unregistered application 512) having the correct exposure level. Thus, the unregistered application 512 may be made aware of the new and/or modified feature of step 514. In certain embodiments, the unregistered application 512 may fetch information from the middleware 508.

In a sixth communication 526 transmitted from the middleware 508 to the registered application 510, the middleware 508 entity may forward an advertisement for the registered application 510 to the registered application 510 (e.g., to an address of the registered application 510) having the correct exposure level (e.g., applications registered with an advertising management system). It should be noted that different registered applications may have different access to information from the FASP 502.

In a seventh communication 528 transmitted from the FASP 502 to the registered application 510 (e.g., optionally via the exposure gateway 506), the FASP 502 sends an advertisement to the registered application 510 (e.g., to an address of the registered application 510). The advertisement may include information unique to the registered application 510.

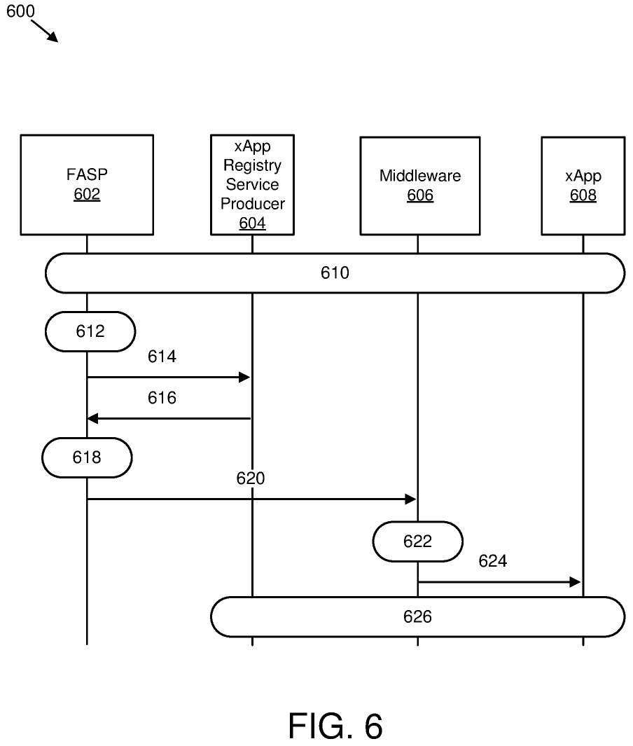

In another embodiment, the communications 400 of FIG. 4 may be implemented in an O-RAN system. FIG. 6 is a communications diagram illustrating such an embodiment of communications 600 for notification of a new management domain feature (e.g., O-RAN system). The communications 600 include messages transmitted between a FASP 602, an xApp registry service producer 604, a middleware 606 (e.g., trusted xApp, trusted rApp, RIC function, API management service), and an xApp 608 (e.g., or xApps, rApp, and/or rApps). As may be appreciated, each communication of the communications 600 may include one or more messages.

In various embodiments of FIG. 6: 1) middleware (e.g., xApp, rApp, RIC function, API management service) may be trusted by an O-RAN management domain to receive information about new and/or modified features; 2) an xApp and/or an rApp may know which management domain to connect to (e.g., via a REST interface URL); 3) an approving authority may be pre-configured to know what exposures an application and/or middleware is authorized to request; and/or 4) an xApp and/or rApp (e.g., depending where the claimed functionality resides—such as in Near-RT RIC or Non-RT RIC) may onboard to an RIC platform.

In a first communication 610 transmitted between the FASP 602, the xApp registry service producer 604, the middleware 606, and the xApp 608, xApps and/or rApps may have been onboarded to an RIC platform.

A new and/or modified feature may be initiated, activated, and/or planned by an SMO. The new and/or modified feature may be a new managed entity (e.g., NF) or a new capability of a given management service (e.g., new and/or updated analytics metric is available from MDAS based on AI/ML model inference at SMO). In some embodiments, a trigger event 612 may indicate that the new and/or modified feature is available.

In a second communication 614 transmitted from the FASP 602 to the xApp registry service producer 604, the FASP 602 (e.g., at SMO) sends a request to the xApp registry service producer (“xARSP”) 604 to receive identities and/or addresses of trusted xApps, trusted rApps, and/or middleware and/or application identifiers for all application servers connected to an O-RAN RIC platform for a given area. In certain embodiments, the request is based on a given service type for which a feature may be targeted (e.g., eMBB or IoT services). In various embodiments, this request may include one or more of the following: a middleware ID (e.g., IP address, FQDN, etc.); an xApp ID; an rApp ID; a service ID; a service profile ID; a geographical area; a topological area; a slice ID for which the request applies; an RIC platform identifier; a cause for request (e.g., new feature, modified feature); and/or a time validity for the request.

In a third communication 616 transmitted from the xARSP 604 to the FASP 602, the xARSP 604 retrieves the information of the registered applications and/or the middleware identity on behalf of the applications. Then xARSP 604 provides this information to the FASP 602. A message carrying this information may include a response (e.g., Yes, No) together with a report including requested identities and API information for reaching the applications (e.g., from URI).

The FASP 602 derives 618 details that can be exposed to each member of a list of applications and/or to the middleware 606 which may act on behalf of the xApp 608. In some embodiments, the FASP 602 may check with an authorization entity (“AE”) to determine whether an application can access requested exposure of management service, management function, management data, and/or MOI.

In a fourth communication 620 transmitted from the FASP 602 to the middleware 606, the FASP 602 provides new and/or modified features to the middleware 606 together with exposure capability requirements and/or target types of services, slices, and/or areas of coverage. The fourth communication 620 may include one or more of the following parameters: a FASP ID; target application identifiers; a target service; a service type; slice identifiers; a target area; a feature identifier or type; a feature name; an exposure required for subscribing to a feature; a feature provider; impacted features; dependent features; required APIs and/or API info; a time validity of a feature; and/or charging aspects.

The middleware 606, after receiving the fourth communication 620, may select 622 to which applications it will advertise a feature.

In a fifth communication 624 transmitted from the middleware 606 to the xApp 608, the middleware 606 may send an advertisement to the xApp 608 (e.g., registered applications—meaning the applications that have unrestricted access to all new and/or current features, or unregistered applications (e.g., onboarded applications). A level of details in the advertisement may depend on implementation and may be a subset or an abstraction of the parameters of step 620.

In a sixth communication 626 transmitted between the xARSP 604, the middleware 606, and the xApp 608, registration and/or a registration update may occur.

In certain embodiments of FIG. 6, the gateway to access FASP 602 may be part of the middleware 606. In various embodiments, the xARSP 604 may be collocated with API management services and/or the middleware 606.

In one example system, a management system from an operator may provide V2X slice support in a new geography, such as Bayern. This capability may be advertised to 3^{rd} party applications, such as BMW applications, that may use these capabilities to provide V2X related services, such as in BMW cars in Bayern.

In another example system, an AI and/or ML model designer, trainer, and/or inference entity (may be an external party) may add a new feature for V2X services in a particular area which may include the provisioning of new analytics metrics for a particular area and time of day (e.g. due to congestion, accident, bad weather, etc.). This may be related to an instance of QoE related analytics metrics. This may be a new feature configured at the MDAS and may be offered to V2X servers (e.g., BMW, VW) in a given area. The new feature may be advertised to the application servers which use a PLMN and/or O-RAN network via middleware as additional value added capability (e.g., with minimum overhead at the end application side).

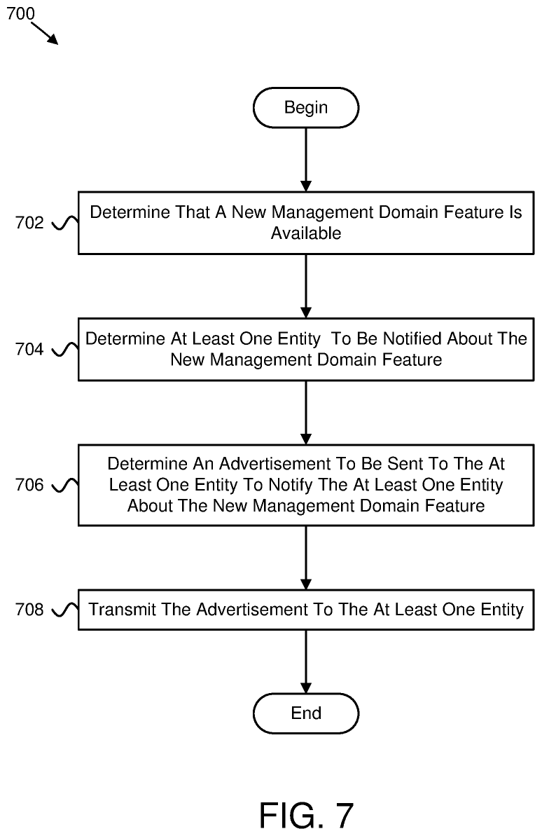

FIG. 7 is a flow chart diagram illustrating one embodiment of a method 700 for notification of a new management domain feature. In some embodiments, the method 700 is performed by an apparatus, such as the network unit 104. In certain embodiments, the method 700 may be performed by a processor executing program code, for example, a microcontroller, a microprocessor, a CPU, a GPU, an auxiliary processing unit, a FPGA, or the like.

In various embodiments, the method 700 includes determining 702 that a new management domain feature is available. In some embodiments, the method 700 includes determining 704 at least one entity to be notified about the new management domain feature. In various embodiments, the method 700 includes determining 706 an advertisement to be sent to the at least one entity to notify the at least one entity about the new management domain feature. In certain embodiments, the method 700 includes transmitting 708 the advertisement to the at least one entity.

In certain embodiments, determining the at least one entity to be notified about the new management domain feature comprises determining the at least one entity to be notified about the new management domain based on the new management domain feature. In some embodiments, determining that the new management domain feature is available comprises determining that the new management domain feature is available by a management service implementation, a set of management functions, a management entity, or a combination thereof. In various embodiments, determining that the new management domain feature is available comprises determining that the new management domain feature is available by a middleware device, a trusted entity, or a combination thereof.

In one embodiment, determining that the new management domain feature is available comprises receiving an indication that the new management domain feature is available, actively discovering that the new management domain feature is available, receiving a trigger event indicating that the new management domain feature is available, or some combination thereof. In certain embodiments, determining that the new management domain feature is available comprises receiving an indication that the new management domain feature is available. In some embodiments, the at least one entity comprises a trusted entity, a known entity, a middleware device, an unknown entity, or some combination thereof.

In various embodiments, the at least one entity comprises at least one application. In one embodiment, determining the advertisement to be sent to the at least one entity comprises determining the advertisement based on information corresponding to the at least one entity and the information about the new management domain feature. In certain embodiments, the new management domain feature comprises a communication method, a service, a target area, associated information, a new service, a new network slice support, a new network function support, a new network slice subnet support, a new physical technology support, a new virtual technology support, a new technology domain support, a new management domain support, a new technical feature, a new business feature, availability of new analytics insights, availability of new analytics models, or some combination thereof.

In one embodiment, a method comprises: determining that a new management domain feature is available; determining at least one entity to be notified about the new management domain feature; determining an advertisement to be sent to the at least one entity to notify the at least one entity about the new management domain feature; and transmitting the advertisement to the at least one entity.

In certain embodiments, determining the at least one entity to be notified about the new management domain feature comprises determining the at least one entity to be notified about the new management domain based on the new management domain feature.

In some embodiments, determining that the new management domain feature is available comprises determining that the new management domain feature is available by a management service implementation, a set of management functions, a management entity, or a combination thereof.

In various embodiments, determining that the new management domain feature is available comprises determining that the new management domain feature is available by a middleware device, a trusted entity, or a combination thereof.

In one embodiment, determining that the new management domain feature is available comprises receiving an indication that the new management domain feature is available, actively discovering that the new management domain feature is available, receiving a trigger event indicating that the new management domain feature is available, or some combination thereof.

In certain embodiments, determining that the new management domain feature is available comprises receiving an indication that the new management domain feature is available.

In some embodiments, the at least one entity comprises a trusted entity, a known entity, a middleware device, an unknown entity, or some combination thereof.

In various embodiments, the at least one entity comprises at least one application.

In one embodiment, determining the advertisement to be sent to the at least one entity comprises determining the advertisement based on information corresponding to the at least one entity and the information about the new management domain feature.

In certain embodiments, the new management domain feature comprises a communication method, a service, a target area, associated information, a new service, a new network slice support, a new network function support, a new network slice subnet support, a new physical technology support, a new virtual technology support, a new technology domain support, a new management domain support, a new technical feature, a new business feature, availability of new analytics insights, availability of new analytics models, or some combination thereof.

In one embodiment, an apparatus comprises: a processor that: determines that a new management domain feature is available; determines at least one entity to be notified about the new management domain feature; and determines an advertisement to be sent to the at least one entity to notify the at least one entity about the new management domain feature; and a transmitter that transmits the advertisement to the at least one entity.

In certain embodiments, the processor determining the at least one entity to be notified about the new management domain feature comprises the processor determining the at least one entity to be notified about the new management domain based on the new management domain feature.

In some embodiments, the processor determining that the new management domain feature is available comprises the processor determining that the new management domain feature is available by a management service implementation, a set of management functions, a management entity, or a combination thereof.

In various embodiments, the processor determining that the new management domain feature is available comprises the processor determining that the new management domain feature is available by a middleware device, a trusted entity, or a combination thereof.

In one embodiment, the apparatus further comprises a receiver, wherein the processor determining that the new management domain feature is available comprises the receiver receiving an indication that the new management domain feature is available, the processor actively discovering that the new management domain feature is available, the receiver receiving a trigger event indicating that the new management domain feature is available, or some combination thereof.

In certain embodiments, the apparatus further comprises a receiver, wherein the processor determining that the new management domain feature is available comprises the receiver receiving an indication that the new management domain feature is available.

In some embodiments, the at least one entity comprises a trusted entity, a known entity, a middleware device, an unknown entity, or some combination thereof.

In various embodiments, the at least one entity comprises at least one application.

In one embodiment, the processor determining the advertisement to be sent to the at least one entity comprises the processor determining the advertisement based on information corresponding to the at least one entity and the information about the new management domain feature.

In certain embodiments, the new management domain feature comprises a communication method, a service, a target area, associated information, a new service, a new network slice support, a new network function support, a new network slice subnet support, a new physical technology support, a new virtual technology support, a new technology domain support, a new management domain support, a new technical feature, a new business feature, availability of new analytics insights, availability of new analytics models, or some combination thereof.

Embodiments may be practiced in other specific forms. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. A method of performing a network function, the method comprising:
determining that a new management domain feature is available;
determining at least one entity to be notified about the new management domain feature;
determining an advertisement to be sent to the at least one entity to notify the at least one entity about the new management domain feature; and
transmitting the advertisement to the at least one entity.

2. The method of claim 1, wherein determining the at least one entity to be notified about the new management domain feature comprises determining the at least one entity to be notified about the new management domain based on the new management domain feature.

3. The method of claim 1, wherein determining that the new management domain feature is available comprises determining that the new management domain feature is available by a management service implementation, a set of management functions, a management entity, or a combination thereof.

4. The method of claim 1, wherein determining that the new management domain feature is available comprises determining that the new management domain feature is available by a middleware device, a trusted entity, or a combination thereof.

5. The method of claim 1, wherein determining that the new management domain feature is available comprises receiving an indication that the new management domain feature is available, actively discovering that the new management domain feature is available, receiving a trigger event indicating that the new management domain feature is available, or a combination thereof.

6. The method of claim 1, wherein determining that the new management domain feature is available comprises receiving an indication that the new management domain feature is available.

7. The method of claim 1, wherein the at least one entity comprises a trusted entity, a known entity, a middleware device, an unknown entity, or a combination thereof.

8. The method of claim 1, wherein the at least one entity comprises at least one application.

9. The method of claim 1, wherein determining the advertisement to be sent to the at least one entity comprises determining the advertisement based on information corresponding to the at least one entity and the information about the new management domain feature.

10. The method of claim 9, wherein the new management domain feature comprises a communication method, a service, a target area, associated information, a new service, a new network slice support, a new network function support, a new network slice subnet support, a new physical technology support, a new virtual technology support, a new technology domain support, a new management domain support, a new technical feature, a new business feature, availability of new analytics insights, availability of new analytics models, or a combination thereof.

11. An apparatus for performing a network function, the apparatus comprising:
at least one memory; and
at least one processor coupled with the at least one memory and configured to cause the apparatus to:
determine that a new management domain feature is available;
determine at least one entity to be notified about the new management domain feature;
determine an advertisement to be sent to the at least one entity to notify the at least one entity about the new management domain feature; and
transmit the advertisement to the at least one entity.

12. The apparatus of claim 11, wherein the at least one processor is configured to cause the apparatus to determine the at least one entity to be notified about the new management domain based on the new management domain feature.

13. The apparatus of claim 11, wherein the at least one processor is configured to cause the apparatus to determine that the new management domain feature is available by a management service implementation, a set of management functions, a management entity, or a combination thereof.

14. The apparatus of claim 11, wherein the at least one processor is configured to cause the apparatus to determine that the new management domain feature is available by a middleware device, a trusted entity, or a combination thereof.

15. The apparatus of claim 11, wherein the at least one processor is configured to cause the apparatus to receive an indication that the new management domain feature is available, discover that the new management domain feature is available, receive a trigger event indicating that the new management domain feature is available, or a combination thereof.

16. The apparatus of claim 11, wherein the at least one processor is configured to cause the apparatus to receive an indication that the new management domain feature is available.

17. The apparatus of claim 11, wherein the at least one entity comprises a trusted entity, a known entity, a middleware device, an unknown entity, or a combination thereof.

18. The apparatus of claim 11, wherein the at least one entity comprises at least one application.

19. The apparatus of claim 11, wherein the at least one processor is configured to cause the apparatus to determine the advertisement based on information corresponding to the at least one entity and the information about the new management domain feature.

20. The apparatus of claim 19, wherein the new management domain feature comprises a communication method, a service, a target area, associated information, a new service, a new network slice support, a new network function support, a new network slice subnet support, a new physical technology support, a new virtual technology support, a new technology domain support, a new management domain support, a new technical feature, a new business feature, availability of new analytics insights, availability of new analytics models, or a combination thereof.
